(19) United States
(12) Patent Application Publication
(10) Pub. No.: US 2023/0040875 A1
(43) Pub. Date: Feb. 9, 2023

(54) Method and Related Systems for Assigning a Status to a User Profile of a Sports Betting Platform

(71) Applicant: Shantanu Alam, Astoria, NY (US)

(72) Inventor: Shantanu Alam, Astoria, NY (US)

(21) Appl. No.: 17/393,433

(22) Filed: Aug. 4, 2021

(51) Int. Cl. G06Q 50/34; G06Q 30/02; G06Q 20/12; G07F 17/32

(52) U.S. Cl. CPC G06Q 50/34; G06Q 30/0201; G06Q 20/12; G07F 17/3288

(57) ABSTRACT

The present disclosure provides a method for calculating a betting accuracy of a user of a sports betting platform based on their betting history over a pre-determined period of time and using a standardised formula, and based on the calculated accuracy meeting one or more threshold requirements, assigning a status to the user profile to allow them to access one or mere features of the betting platform. A system for implementing the method is also provided herein.

### FIELD OF INVENTION

The present invention relates generally to the field of sports betting. More specifically, the present invention relates to methods and systems for measuring the accuracy of a user profile based on their betting history and assigning a status to the profile.

### BACKGROUND

Millions of people worldwide engage in various types of gambling or betting, i.e. the wagering of money or assets on an event having an uncertain outcome, with the primary intent of winning money or a prize or reward. In some gambling games, the outcome may be immediate, such as when a dice is rolled or when a roulette wheel is spun. In other gambling games, longer time frames may be involved. For example, in sports betting, a user may guess or predict sports results, and may place a wager on the outcome of a sporting event, e.g., predicting the final outcome of a basketball game, or predicting the winner in a horse race.

Over recent years, as network technology and mobile devices have improved, a large portion of the world of gambling has shifted onto the internet, and online betting platforms are now a multi-billion dollar industry. With gambling now easily accessible to any person with an internet-enabled device, more and more amateur betters are entering the space, and there is a desire for a reliable way for these individuals to have access to the betting patterns of expert analysts who have deep knowledge and experience in particular fields of betting. Furthermore, it is desirable for such experts to have a way of earning status and even regular income using their expertise.

In light of these needs, solutions have been developed for users to gain access to betting picks of experts so that they can bet the same way, sometimes paying for the privilege to do so.

US2021074127A1 discloses methods for one person to be able to bet on and be part of the deal and excitement for a third party, as his agent, proxy, or shadow, to bet for him, or instead of him, or as if the first person was doing the game directly, or one betting for another, or one playing for another with the other person's money. That generates more excitement on the game or casino, with more participation, transactions, income, profit, loyalty, and repeat customers. This brings a lot of variations on the game, e.g., stock market model, or derivatives model, or hedge model. This can be applied to sports and table games or fantasy sports. This can be applied to online, real, mobile, fantasy, simulation, computer generated, human based, or casino games or settings.

US2016371935A1 discloses a wagering system which includes a social media system comprising a content module operable via a processor on a computing device to display a plurality of content to a plurality of users on a mobile device and a content module to display the plurality of content on the mobile device. An evaluation system evaluates a prediction history of one or more experts and assigns a value to the one or more expert predictions. The value corresponds to a payment required for the user to receive the one or more expert predictions. A wagering system permits the creation and execution of one or more wagers and a book database to store a plurality of wager parameters. The book database is in operable communication with a wager processor to receive one or more wagers from a plurality of users, and one or more accepted wager parameters.

Both of these disclosures describe a set of trusted users or “experts” that supposedly have good betting accuracy, but neither disclosure, nor any disclosure of the prior art, describes a standardized method for determining these experts, nor for allowing a user of a betting platform to achieve such expert status.

It is within this context that the present invention is provided.

### SUMMARY

The present disclosure provides a method for calculating a betting accuracy of a user of a sports betting platform based on their betting history over a pre-determined period of time and using a standardised formula, and based on the calculated accuracy meeting one or more threshold requirements, assigning a status to the user profile to allow them to access one or more features of the betting platform. A system for implementing the method is also provided herein.

Thus, according to one aspect of the present disclosure there is provided a computer-implemented method of assigning a status to a user of a sports betting platform, the method comprising the steps of: receiving a bet history dataset associated with a user profile of a user, the bet history dataset including at least: a list of bets placed on the betting platform by the user within a predetermined time period, and an outcome of each bet in the list; determining that the bet history dataset of the user meets one or more threshold criteria; and if the bet history dataset meets the one or more threshold criteria, calculating a betting accuracy of the user profile over the predetermined time period based on the bet history dataset by dividing the number of listed bets having a correct outcome by the total number of bets placed.

The method further comprises the steps of, based on the calculated accuracy of the user profile over the predetermined time period, assigning or updating a status associated with the user profile to indicate the accuracy level, the status being selected from a list of statuses associated with different accuracy levels; and if the accuracy level meets one or more accuracy thresholds, providing the user profile with access to one or more features of the betting platform.

In some embodiments, the list of bets included in the bet history dataset may include at least two types of bet: standard bets, and best bets which may only be placed one per day, and wherein the calculations for determining the betting accuracy of the user profile are based solely on the best bets included in the dataset.

Furthermore, the one or more threshold criteria may include the requirement for having placed a best bet on the betting platform for a predetermined number of consecutive days.

In some embodiments, the bet history dataset further includes a category of bet associated with each bet in the list of bets.

In such embodiments, the method further includes determining a user profile betting accuracy within each category and assigning a specialist status to the profile if the bet history dataset meets one or more threshold criteria for a given category and the calculated accuracy within that category is over a predetermined threshold.

The categories may include one or more sports. The sports may include one or more of basketball, American football, and hockey, or any other appropriate sport.

In some embodiments, the bet history dataset includes one or more sub-categories indicating a league associated with each bet when the bet is in relation to a sport having leagues.

Additionally, the method further may include determining a user profile betting accuracy within each sub-category and assigning a specialist status to the profile if the bet history dataset meets one or more threshold criteria for a given sub-category and the calculated accuracy within that sub-category is over a predetermined threshold.

The bet history dataset could also include one or more underdog bets, each underdog bet indicating a bet where the user profile correctly bet on an unfavoured outcome of a sporting match, and wherein each underdog bet provides a bonus to the calculation of the betting accuracy of the user profile.

In some embodiments, the accuracy thresholds include one or more ranges of percentages, and wherein the status assigned to a user profile includes a number of stars based on the percentage accuracy calculated by the method.

In some embodiments, the one or more features of the betting platform include the option for other user profiles to purchase betting picks submitted by the user profile on the betting platform.

According to another aspect of the present disclosure, there is provided a system for assigning a status to a user of a sports betting platform, the system comprising: one or more databases configured to store data for one or more user profiles, the user data including a bet history dataset associated with each profile that indicates the bets the profile has made, the outcomes associated with the bets, and other data related to the bets; one or more servers in wired or wireless communication with the one or more databases and one or more user devices, the one or more servers being configured to carry out the method of any one of the above-described embodiments.

### BRIEF DESCRIPTION OF THE DRAWINGS

Various embodiments of the invention are disclosed in the following detailed description and accompanying drawings.

FIG. 1 illustrates a diagrammatic view of an example configuration of a wireless network architecture over which the methods of the present disclosure may be implemented.

FIG. 2 illustrates a flow diagram of a set of steps for carrying out a method according to the present disclosure.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The term “server” as used herein may refer to one or more physical servers in a single location, or may refer to a distributed network of servers forming a cloud storage service. Cloud storage services allow a user to store information, such as computer files, in a remote storage destination located “online” or “in the cloud”. The remote storage destination may be located geographically far away from whatever computing node the user works with. The remote storage may communicate with the user's computing node over a local area network (LAN), a wide area network (WAN), and/or the Internet. The remote storage destination device may include a cloud storage service, a remote IP addressable hard drive, a laptop computer, and the like. The cloud storage network may be owned and/or operated by the user, the user's organization (e.g., a corporations information technology (IT) group), or a third party. Cloud based storage provides a convenience for the user in that he or she does not need to maintain the hardware associated with such storage. Further, the user may access his or her information stored in the cloud via various computing nodes located in dispersed geographic locations.

Provided herein are systems and methods for assessing the accuracy with which a user of a betting platform has predicted outcomes of one or more betting events over a predetermined period of time, and when the user is determined to have meth one or more threshold accuracy requirements, assigning a status to the user profile allowing them access to one or more features of the betting platform.

The present disclosure first presents a wireless network architecture of client devices and server side devices over which the present methods can be implemented, then describes an example set of steps forming such a method.

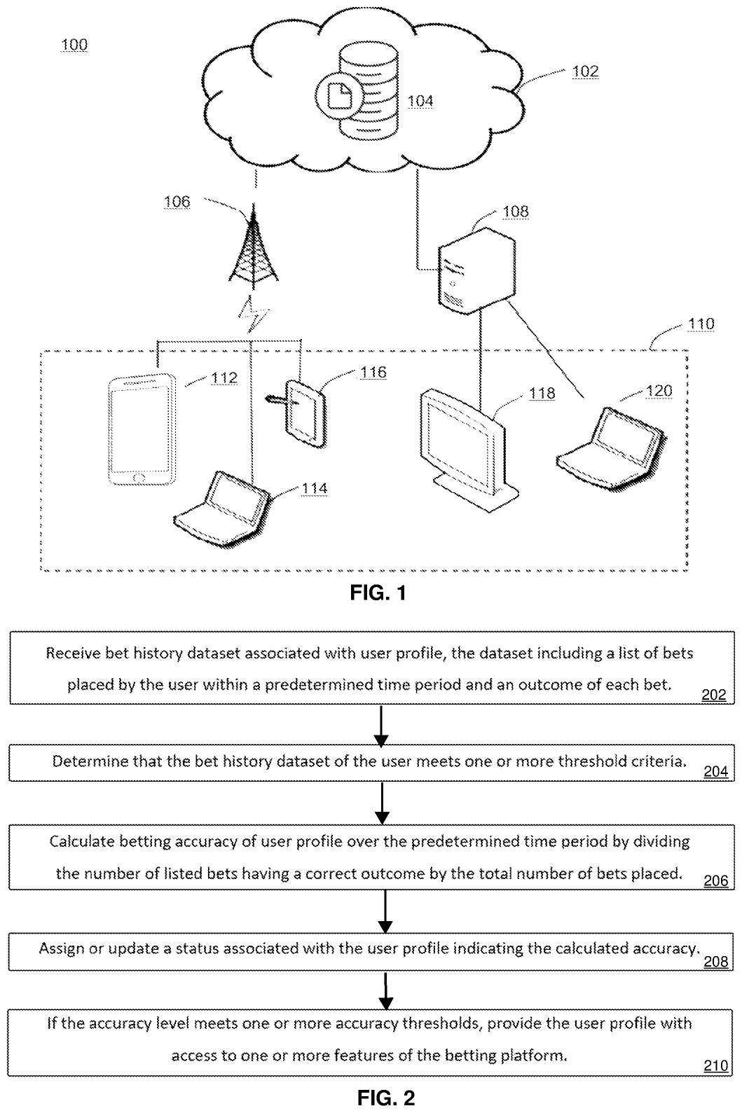

Referring to FIG. 1 an example network architecture 100 is shown over which multimedia content and user data for wired and wireless implementations of the disclosed system can be stored, transmitted, and consumed.

One or more of the operations and calculations described herein may be performed by a cloud infrastructure 102 comprising one or more servers and databases 104. This is merely an example infrastructure however, the servers need not necessarily be cloud-based. Either way, the one or more databases must configured to store data for one or more user profiles as well as a bet history dataset associated with each profile that indicates the bets the profile has made, the outcomes associated with the bets, and other data related to the bets.

The architecture 100 may thus amounts to a system for assigning a status to a user of a betting platform.

The cloud infrastructure 102 may for example comprise a database 104 configured to receive and store multimedia content and user data for a plurality of user accounts and a set of connected servers or nodes configured to enact the operations as disclosed herein.

The cloud infrastructure 102 is configured to communicate with a set of client devices 110 by various means over the illustrated network architecture. The illustrative client devices 110 include devices configured to communicate with the cloud infrastructure 102 via a communications tower 106. These devices may include but are not limited to a smartphone 112, a laptop 114, and a tablet computer 116.

Additional client devices configured to communicate with the cloud infrastructure 102 via a networked computer modem 108 include but are not limited to a smart display 118 and a second laptop 120. Some of the connections may be wired connections, such as the connection between the smart display 118 and the networked computer modem 108.

Any one of the client devices 110 may be operationally coupled to a wide area network (WAN) such as the Internet with a wireless connection. The wireless clients may be communicatively coupled to the WAN via a Wi-Fi (or Bluetooth) access point that is communicatively coupled to a modem, which is communicatively coupled to the WAN. The wireless clients may also be communicatively coupled to the WAN using a proprietary carrier network that includes illustrative communication tower 106.

While a specific set of client devices are illustrated in the architecture of FIG. 1 the client devices may in fact be any suitable device. For example, client devices could include a mobile handset, mobile phone, wireless phone, portable cell phone, cellular phone, portable phone, a personal digital assistant (PDA), a tablet, a portable media device, a wearable computer, or any type of mobile terminal which is regularly carried by an end user and has all the elements necessary for operation in a wireless communication system. The wireless communications include, by way of example and not of limitation, CDMA, WCDMA, GSM, UMTS, or any other wireless communication system such as wireless local area network (WLAN), Wi-Fi or WiMAX.

Each client device 110 may be associated with or “logged in” to a user profile in order to operate within the disclosed system and method, and further configured to send requests, upload user data, and generally interact with the cloud infrastructure 102 via a user interface displayed on the device.

Referring to FIG. 2, a flow diagram of an example set of steps forming the method of assigning a status to a user of a betting platform is shown.

In a first step 202, the method involves receiving a bet history dataset associated with a user profile of a user, the bet history dataset including at least: a list of bets placed on the betting platform by the user within a predetermined time period, and an outcome of each bet in the list.

For example, the predetermined period may be the previous 30 days.

In some examples, the bet history dataset further includes a category of bet associated with each bet in the list of bets. The categories may include one or more sports. The sports may include one or more of basketball, American football, and hockey, or any other appropriate sport. Furthermore, the sports may be divided into sub-categories indicating a league associated with each bet when the bet is in relation to a sport having leagues.

The list of bets included in the bet history dataset may include at least two types of bet: standard bets, and best bets which may only be placed one per day.

Additional types of bets may also be included in the dataset, such as the number of times a user bet on an “underdog”, i.e. a team that was considered unlikely to win.

In a second step 204, the method involves determining that the bet history dataset of the user meets one or more threshold criteria. For example, the threshold criteria may include the requirement that the user profile has placed 20 consecutive best bets on the platform.

The requirements may also include category or sub-category specific requirements, such as having placed a minimum number of bets in a specific sport or league in the time period, i.e. the last 30 days.

Each requirements may allow a user profile to gain a chance at acquiring a different kind of status on the platform, such as star analyst for general betting accuracy, or sport specialist or league specialist for the different categories and sub-categories.

In a third step 206, if the bet history dataset of the user profile meets the one or more threshold criteria, the method involves calculating a betting accuracy of the user profile over the predetermined time period based on the bet history dataset by dividing the number of listed bets having a correct outcome by the total number of bets placed.

This calculation may be done using the overall statistics for statuses like star analyst, or using only statistics from specific leagues or sports for specialist tatus.

Furthermore, certain types of bets such as the aforementioned underdog bet, may be weighted in the calculation to increase the accuracy rating of the user profile more than a normal type of bet.

In a fourth step 208, the method involves, based on the calculated accuracy of the user profile over the predetermined time period, assigning or updating a status associated with the user profile to indicate the accuracy level, the status being selected from a list of statuses associated with different accuracy levels.

The accuracy levels or thresholds can for example include one or more ranges of percentages, such as a one star rating for user profiles having scored in the 55% to 64.99% range, a two star status for user profiles having scored in the 65-74.99% range, and a three star rating for user profiles having scored 75% or above. Of course, other rating ranges and statuses may also be used.

For specific categories and sub-categories, the threshold accuracy may be a single requirement, such as the requirement of achieving a rating of 65% or more accuracy within a specific league or sport to achieve specialist status.

In a fifth step 210, if the accuracy level of the user profile meets the one or more accuracy thresholds, the method involves providing the user profile with access to one or more features of the betting platform.

In general, this involves advertising the user profile as having the status achieved, and allowing other users of the platform to access the betting picks of the user profile in exchange for money, with a percentage of the money paid going to the user profile.

Additional optional features of the system include the provision of an accuracy test which allows user of the betting platform to assess their own accuracy within the system without actually placing real bets.

It should be understood that the operations described herein may be carried out by any processor. In particular, the operations may be carried out by, but are not limited to, one or more computing environments used to implement the method such as a data center, a cloud computing environment, a dedicated hosting environment, and/or one or more other computing environments in which one or more assets used by the method re implemented; one or more computing systems or computing entities used to implement the method; one or more virtual assets used to implement the method; one or more supervisory or control systems, such as hypervisors, or other monitoring and management systems, used to monitor and control assets and/or components; one or more communications channels for sending and receiving data used to implement the method; one or more access control systems for limiting access to various components, such as firewalls and gateways; one or more traffic and/or routing systems used to direct, control, and/or buffer, data traffic to components, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the method; one or more databases used to store data; one or more internal or external services used to implement the method; one or more backend systems, such as backend servers or other hardware used to process data and implement the method; one or more software systems used to implement the method; and/or any other assets/components in which the method is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

As used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

Unless specifically stated otherwise, as would be apparent from the above discussion, it is appreciated that throughout the above description, discussions utilizing terms such as, but not limited to, “activating”, “accessing”, “adding”, “applying”, “analyzing”, “associating”, “calculating”, “capturing”, “classifying”, “comparing”, “creating”, “defining”, “detecting”, “determining”, “eliminating”, “extracting”, “forwarding”, “generating”, “identifying”, “implementing”, “obtaining”, “processing”, “providing”, “receiving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system for assigning a status to a user profile of a betting platform have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer-implemented method of assigning a status to a user of a sports betting platform, the method comprising the steps of:
receiving a bet history dataset associated with a user profile of a user, the bet history dataset including at least: a list of bets placed on the betting platform by the user within a predetermined time period, and an outcome of each bet in the list;
determining that the bet history dataset of the user meets one or more threshold criteria;
if the bet history dataset meets the one or more threshold criteria, calculating a betting accuracy of the user profile over the predetermined time period based on the bet history dataset by dividing the number of listed bets having a correct outcome by the total number of bets placed;
based on the calculated accuracy of the user profile over the predetermined time period, assigning or updating a status associated with the user profile to indicate the accuracy level, the status being selected from a list of statuses associated with different accuracy levels; and
if the accuracy level meets one or more accuracy thresholds; providing the user profile with access to one or more features of the betting platform.

2. A computer-implemented method according to claim 1, wherein the list of bets included in the bet history dataset includes at least two types of bet: standard bets, and best bets which may only be placed one per day, and wherein the calculations for determining the betting accuracy of the user profile are based solely on the best bets included in the dataset.

3. A computer-implemented method according to claim 2, wherein the one or more threshold criteria include the requirement for having placed a best bet on the betting platform for a predetermined number of consecutive days.

4. A computer-implemented method according to claim 1, wherein the bet history dataset further incudes a category of bet associated with each bet in the of bets.

5. A computer-implemented method according to claim 4, wherein the method further includes determining a user profile betting accuracy within each category and assigning a specialist situs to the profile if the bet history dataset meets one or more threshold criteria for a given category and the calculated accuracy within that category is over a predetermined threshold.

6. A computer-implemented method according to claim 4, wherein the categories include one or more sports.

7. A computer-implemented method according to claim 4, wherein the sports include one or more of basketball, American football, and hockey.

8. A computer-implemented method according to claim 1, wherein the bet history dataset includes one or more sub-categories indicating a league associated with each bet when the bet is in relation to a sport having leagues.

9. A computer-Implemented method according to claim 8, wherein the method further includes determining a user profile betting accuracy within each sub-category and assigning a specialist status to the profile if the bet history dataset meets one or more threshold criteria for a given sub-category and the calculated accuracy within that sub-category over a predetermined threshold.

10. A computer-implemented method according to claim 1, wherein the bet history dataset includes one or more underdog bets, each underdog bet indicating a bet where the user profile correctly bet on an unfavoured outcome of a sporting match, and wherein each underdog bet provides a bonus to the calculation of the betting accuracy of the user profile.

11. A computer-implemented method according to claim 1, % wherein the accuracy thresholds include one or more ranges of percentages, and wherein the status assigned to a user profile includes a number of stars based on the percentage accuracy calculated by the method.

12. A computer implement method according to claim 1, wherein the one or more features of the betting platform include the option for other user profiles to purchase betting picks submitted by the user profile on the betting platform.

13. A system for assigning a status to a user of a sports betting platform, the system comprising:
one or more databases configured to store data for one or more user profiles, the user data including a bet history dataset associated with each profile that indicates the bets the profile has made, the outcomes associated with the bets, and other data related to the bets;
one or more servers in wired or wireless communication with the one or more databases and one or more user devices, the one or more servers being configured to carry out the method of any one of claims 1 to 12.
